(19) United States
(12) Patent Application Publication
(10) Pub. No.: US 2026/0045054 A1
(43) Pub. Date: Feb. 12, 2026

(54) METHOD, APPARATUS, DEVICE AND STORAGE MEDIUM FOR PRESENTING VIRTUAL SCENE

(71) Applicant: Beijing Youzhuju Network Technology Co., Ltd., Beijing (CN)

(72) Inventor: Zihan ZHAO, Beijing (CN)

(21) Appl. No.: 19/099,030

(22) PCT Filed: Nov. 28, 2023
(86) PCT No.: PCT/CN2023/134844

§ 371 Date: Jan. 27, 2025

(30) Foreign Application Priority Data
Jan. 18, 2023 (CN) 202310102347.6

(51) Int. Cl. G06T 19/20; G02B 27/01; G06F 3/01; H04N 7/15; H04N 21/2187

(52) U.S. Cl. CPC G06T 19/20; G02B 27/017; G06F 3/011; H04N 7/157; H04N 21/2187

(57) ABSTRACT

A method, a device and a storage medium for presenting a virtual scene are provided. The method includes: receiving a request to access a virtual scene by a first user of a virtual live streaming application, the virtual scene being associated with a physical scene which a second user of the virtual live streaming application is currently in, and the physical scene including a physical object; presenting the virtual scene to the first user based on the request, the virtual scene including an avatar associated with the second user and a virtual object associated with the physical object; and presenting an updated virtual scene to the first user based on a request by the first user to switch to a target pose in the virtual scene, the updated virtual scene including an updated avatar of the second user and an updated virtual object determined based on the target pose.

This application claims the priority of the Chinese patent application No. 202310102347.6, filed on Jan. 18, 2023 and entitled “METHOD, APPARATUS, DEVICE AND STORAGE MEDIUM FOR PRESENTING VIRTUAL SCENE”, the disclosure of which is incorporated herein by reference in its entirety.

### FIELD

Example embodiments of the present disclosure generally relate to the field of computer and, in particular, to a method, an apparatus, an electronic device and a computer storage medium for presenting a virtual scene.

### BACKGROUND

In recent years, Extended Reality (abbreviated as XR) has been widely studied and applied. XR uses a combination of hardware devices and various technical means to integrate virtual content and real scenes to provide users with a unique sensory experience. XR includes, for example, Virtual Reality (abbreviated as VR), Augmented Reality (abbreviated as AR), Mixed Reality (abbreviated as MR), and the like.

VR uses a computer to simulate a virtual scene of a three-dimensional space to provide users with immersive experience in terms of vision, hearing, touch, and the like. AR enables a real environment and a virtual object to be superimposed in the same space in real time and coexist at the same time. MR is a new visual environment that integrates a physical scene and a virtual scene, and objects in the physical scene coexist with objects in the virtual scene in real time. At this time, how to present a virtual scene to improve user experience has become a research hotspot.

### SUMMARY

In a first aspect of the present disclosure, a method for presenting a virtual scene is provided. The method includes: receiving a request to access the virtual scene by a first user of a virtual live streaming application, the virtual scene being associated with a physical scene which a second user of the virtual live streaming application is currently in, and the physical scene including a physical object. Further, the virtual scene is presented to the first user based on the request, the virtual scene including an avatar associated with the second user and a virtual object associated with the physical object. Further, an updated virtual scene is presented to the first user based on a request by the first user to switch to a target pose in the virtual scene, the updated virtual scene including an updated avatar of the second user and an updated virtual object determined based on the target pose.

In a second aspect of the present disclosure, an apparatus for presenting a virtual scene is provided. The apparatus includes: a receiving module configured to receive a request to access the virtual scene by a first user of a virtual live streaming application, the virtual scene being associated with a physical scene which a second user of the virtual live streaming application is currently in, and the physical scene including a physical object. The apparatus further includes: a first presenting module configured to present the virtual scene to the first user based on the request, the virtual scene including an avatar associated with the second user and a virtual object associated with the physical object. The apparatus further includes: a second presenting module configured to present an updated virtual scene to the first user based on a request by the first user to switch to a target pose in the virtual scene, the updated virtual scene including an updated avatar of the second user and an updated virtual object determined based on the target pose.

In a third aspect of the present disclosure, an electronic device is provided, including: a memory and a processor, where the memory is configured to store one or more computer instructions, and the one or more computer instructions are executed by the processor to implement the method according to the first aspect of the present disclosure.

In a fourth aspect of the present disclosure, a computer-readable storage medium having stored thereon one or more computer instructions is provided, where the one or more computer instructions are executed by a processor to implement the method according to the first aspect of the present disclosure.

### BRIEF DESCRIPTION OF THE DRAWINGS

The above and other features, advantages and aspects of various embodiments of the present disclosure will become more apparent when taken in conjunction with the drawings and with reference to the following detailed description. In the drawings, the same or similar reference numerals denote the same or similar elements, where:

FIG. 1 illustrates a schematic diagram of an example environment in which embodiments according to the present disclosure can be implemented;

FIG. 2A to FIG. 2F illustrate schematic diagrams of examples of presenting a virtual scene according to some embodiments of the present disclosure, respectively;

FIG. 3 illustrates a flow chart of a process of presenting a virtual scene according to some embodiments of the present disclosure;

FIG. 4 illustrates a schematic block diagram of an apparatus for presenting a virtual scene according to some embodiments of the present disclosure; and

FIG. 5 illustrates a block diagram of an electronic device capable of implementing a plurality of embodiments of the present disclosure.

### DETAILED DESCRIPTION

Embodiments of the present disclosure are described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a more thorough and complete understanding of the present disclosure. It should be understood that the drawings and embodiments of the present disclosure are only for exemplary purposes and are not intended to limit the scope of protection of the present disclosure.

In the description of the embodiments of the present disclosure, the term “include/include” and similar terms should be understood as open-ended inclusions, that is, “include/include but not limited to”. The term “based on” should be understood as “at least partially based on”. The term “one embodiment” or “an embodiment” should be understood as “at least one embodiment”. The terms “first”, “second”, and the like may refer to different or the same objects. Other explicit and implicit definitions may be included below.

It can be understood that the data involved in the technical solutions of the present disclosure (including but not limited to the data itself, and the acquisition or use of the data) should comply with requirements of corresponding laws and regulations and related provisions.

It can be understood that before using the technical solutions disclosed in the embodiments of the present disclosure, the user should be informed of the type, the range of use, the usage scenarios, and the like of the personal information involved in the present disclosure in an appropriate manner according to relevant laws and regulations, and the authorization of the user should be obtained.

For example, in response to receiving an active request from the user, prompt information is sent to the user to explicitly prompt the user that the operation requested to be performed will require the acquisition and use of the user's personal information. Thus, the user may independently choose whether to provide the personal information to software or hardware such as an electronic device, an application, a server, or a storage medium that performs the operations of the technical solutions of the present disclosure, according to the prompt information.

As an optional but non-limiting implementation, the manner of sending prompt information to the user in response to receiving an active request from the user may be, for example, a pop-up window, and the prompt information may be presented in text in the pop-up window. In addition, the pop-up window may further include a selection control for the user to select “agree” or “disagree” to provide the personal information to the electronic device.

It can be understood that the above process of notifying and acquiring user authorization is only illustrative, and does not limit the implementations of the present disclosure. Other manners that satisfy relevant laws and regulations may also be applied to the implementations of the present disclosure.

The term “in response to” means that a corresponding event occurs or a condition is satisfied. It will be understood that the execution timing of the subsequent action performed in response to the event or condition is not necessarily strongly associated with the time when the event occurs or the condition is satisfied. In some cases, the subsequent action may be performed immediately when the event occurs or the condition is satisfied; in other cases, the subsequent action may be performed after a period of time since the event occurs or the condition is satisfied.

In the description of the embodiments of the present disclosure, the term “virtual scene” includes but is not limited to virtual scenes implemented by technologies such as “XR”, “VR”, “AR” and “MR”. It should be understood that the term “virtual scene” may be implemented by any one of “XR”, “VR”, “AR” and “MR”, or any combination thereof.

As briefly mentioned above, extended reality technology may generate a virtual scene and allow users to join the virtual scene, so as to provide interaction for the users. For example, such a virtual scene is a virtual conference scene, and users join the virtual conference scene through virtual avatars generated by virtual scene generation devices for discussion. For another example, such a virtual scene is a virtual live streaming room. The virtual scene generation device generates a virtual body of a host, and the host recommends and introduces products to an audience in the virtual live streaming room. Therefore, users can achieve an immersive interaction experience.

At present, video-based virtual live streaming room applications have been developed, and viewers may watch the video of the live streaming room in real time. However, the viewers cannot browse the three-dimensional effects of the live streaming room and products in real time. Although a three-dimensional model may be established for a product and presented in a virtual live streaming room, the interaction manners provided by the virtual live streaming room are extremely limited, and a user may only watch the live streaming images from a specific angle, which results in that the user cannot know the detailed information of the live streaming room and the product in real time. Especially when the scale of the product is large (for example, furniture, electrical appliances, houses, etc.), it is difficult for the user to feel the overall information of the product. At this time, it is expected that richer information can be provided to the user in the virtual live streaming room according to user interaction.

In view of this, embodiments of the present disclosure provide a solution for presenting a virtual scene. According to this solution, a request to access a virtual scene by a first user (for example, a viewer) of a virtual live streaming application is received, the virtual scene is associated with a physical scene which a second user (for example, a host) of the virtual live streaming application is currently in, and the physical scene includes a physical object. Further, the virtual scene is presented to the first user based on the request, the virtual scene including an avatar associated with the second user and a virtual object associated with the physical object. Further, an updated virtual scene is presented to the first user based on a request by the first user to switch to a target pose in the virtual scene, the updated virtual scene including an updated avatar of the second user and an updated virtual object determined based on the target pose.

In this way, embodiments of the present disclosure can generate a virtual scene associated with the physical scene which the second user is currently in and the physical object included in the physical scene. Therefore, the first user can perceive and experience the physical scene in which the second user is placed and the physical object existing in the physical scene, by accessing the virtual scene, so as to provide the first user with an interaction feeling close to interacting with the second user and the physical object in the physical scene. On this basis, the presentation content for the first user can be adjusted according to the pose of the first user in the virtual scene, so as to further enhance the interaction experience of the first user in the virtual scene.

### Example Environment

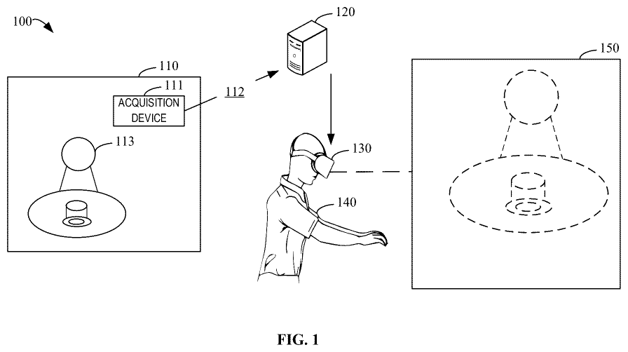

Referring first to FIG. 1, it illustrates a schematic diagram of an example environment in which embodiments according to the present disclosure can be implemented.

As shown in FIG. 1, the environment 100 may include a physical scene 110, a server 120, and an electronic device 130, and a first user (for example, a user 140) may access a corresponding virtual scene 150 of the physical scene 110. Such a physical scene 110 is a physical scene which a second user (for example, a user 113) is in. For example, in the case that the second user is a host, such a physical scene 110 is, for example, a live streaming room. The physical scene 110 further includes an acquisition device 111, and the acquisition device 111 is used to acquire measurement data 112 of the physical scene 110. Such an acquisition device 111 is, for example, a separate visible light image acquisition device, a point cloud data acquisition device, an infrared image acquisition device, or a combination of the above-mentioned types of acquisition devices. Correspondingly, the measurement data acquired by the acquisition device 111 may be, for example, a panoramic image, three-dimensional point cloud data, an infrared image, and the like. The acquisition device 111 may send the acquired measurement data 112 to the server 120, so that the server 120 may generate the virtual scene (for example, the virtual scene 150) of the first scene 110 by using the measurement data 112. In some embodiments, the acquisition device 111 further includes an audio acquisition device, such as a microphone. Therefore, the acquisition device 111 may acquire audio data in the physical scene 110 and provide it to the server 120. Correspondingly, the virtual scene (for example, the virtual scene 150) generated by the server 120 may further include the audio in the physical scene 110, which further improves the restoration quality of the virtual scene (for example, the virtual scene 150) to the physical scene 110.

The server 120 may communicate with the acquisition device, for example, the acquisition device 111, to receive the measurement data (for example, the measurement data 112), and then generate the virtual scene (for example, the virtual scene 150) based on the measurement data. For example, a server, a computing node, etc. for image or data processing. For example, the server 120 generates the virtual scene 150 by using a visible light image acquisition device to acquire a panoramic image of the physical scene 110. For example, the server 120 uses the acquisition device to acquire a panoramic image and a three-dimensional point cloud data by using a point cloud data acquisition device to generate the virtual scene 150.

In some embodiments, the server 120 may associate the generated virtual scene (for example, the virtual scene 150) with an application (for example, the virtual live streaming application), so that the user can access the virtual scene by using the application.

The electronic device 130 may be used by the user 140 to present the virtual scene (for example, the virtual scene 150) to the user 140. Such an electronic device 130 is, for example, a head-mounted display, smart glasses, etc. After communicating with the server 120 (for example, the electronic device 130 sends an access request to access the virtual scene to the server 120, for example, the user 140 sends an access request for the virtual scene by using the virtual live streaming application in the electronic device), the electronic device 130 may receive the data generated for presenting the virtual scene (for example, the data for presenting the virtual scene sent by the server 120 to the electronic device 130 after the above access request), and then present the virtual scene (for example, the virtual scene 150) to the user 140. In some embodiments, in the case that the processing capability of the electronic device 130 satisfies a requirement (for example, an image processing capability, a three-dimensional reconstruction capability, a rendering capability, etc.), the electronic device 130 may also directly communicate with the acquisition device 111 to acquire the measurement data 112, and then generate the virtual scene 150 based on the measurement data 112. In this case, the electronic device 130 may also be integrated with the server 120, and all functions of the server 120 may be realized by using the electronic device 130.

Further, the electronic device 130 may be used by the user 140 for interaction in the virtual scene 150. For example, the electronic device 130 may switch the pose of the user 140 in the virtual scene 150 according to an operation of the user 140, or adjust the content of the virtual scene 150 presented to the user 140. For example, in the case that the electronic device 130 currently presents the content at a first spatial position in the virtual scene 150 to the user 140, the electronic device 130 may adjust to a second spatial position in the virtual scene 150 according to an operation of the user 140, and present the content at the second spatial position in the virtual scene 150 to the user 140 accordingly.

For the convenience of description, the electronic device 130 is only taken as an example execution subject that presents the virtual scene (for example, the virtual scene 150) to the user and implements the method for presenting the virtual scene.

It should be understood that the structure and function of the environment 100 are described for exemplary purposes only, without implying any limitation to the scope of the present disclosure. Some example embodiments of the present disclosure will continue to be described below with reference to the drawings.

### Example Generation of Virtual Scene

As described above, in the virtual live streaming room application, a virtual scene can usually be generated by using a stored virtual scene and a prestored virtual object pre-configured in a virtual scene generation device. For example, when the virtual scene generation device provides a virtual live streaming room for a user, it calls, for example, a stored shopping mall or booth scene, and a stored product.

However, in this way, since the stored virtual scene and the prestored virtual object need to occupy a large amount of storage resources, it is difficult to store quite a few stored virtual scenes at the same time. Correspondingly, the stored virtual scene and the prestored virtual object provided by the virtual scene generation device for the user may be greatly different from the user's expectation, which significantly affects the user interaction experience in the virtual scene.

In order to enable the virtual scene provided for the first user to be associated with the physical scene which the second user is currently in, and thus enable the first user achieves, based on the virtual scene, an interaction experience with the second user in the physical scene which the second user is currently in, embodiments of the present disclosure may generate a virtual scene including an avatar of the first user and a virtual object of a physical object in the physical scene based on measurement data of the physical scene which the second user is currently in. The first user can perceive and experience the physical object included in the physical environment in which the second user is placed, by accessing the virtual scene.

In some embodiments, such a physical scene may be a live streaming room, for example, a three-dimensional physical space in which a host introduces and recommends physical products (for example, hats, shampoos, etc.) to a viewer online. Accordingly, in the case that the physical scene is a live streaming room, the second user may be a host, and the first user may be a viewer who watches the live streaming and listens to the host's explanation. Further, such a virtual scene is a virtual scene based on a three-dimensional model. Therefore, the viewer can access the virtual scene to watch the live streaming in the “immersive” live streaming room, and use the virtual object to watch and perceive the products introduced by the host in real time and intuitively, so as to have a more intuitive understanding of the content introduced by the host.

In some embodiments, such a physical scene may be a house, for example, a commercial housing, a rental housing, etc., for example, a house seller (for example, a house owner, a house agent, etc.) gives a real-time introduction of the house to a viewer in a house to be sold. Accordingly, in the case that the physical scene is a house, the second user may be a house seller, and the first user may be a viewer who expects to buy the house and get knowledge of the house. Further, such a virtual scene is a virtual scene based on a three-dimensional model. Therefore, the viewer can access the virtual scene to feel the layout of the house, the furniture display in the house, and so on in an “immersive” way. Accordingly, the viewer can get knowledge of the layout of the house and the furniture in the house by observing and walking around in the virtual scene, so as to have a better understanding of the house.

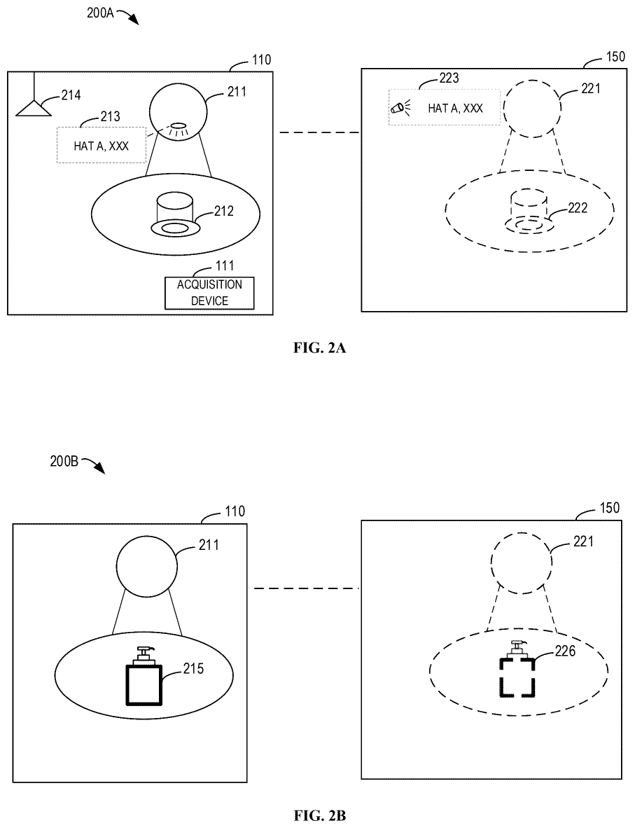

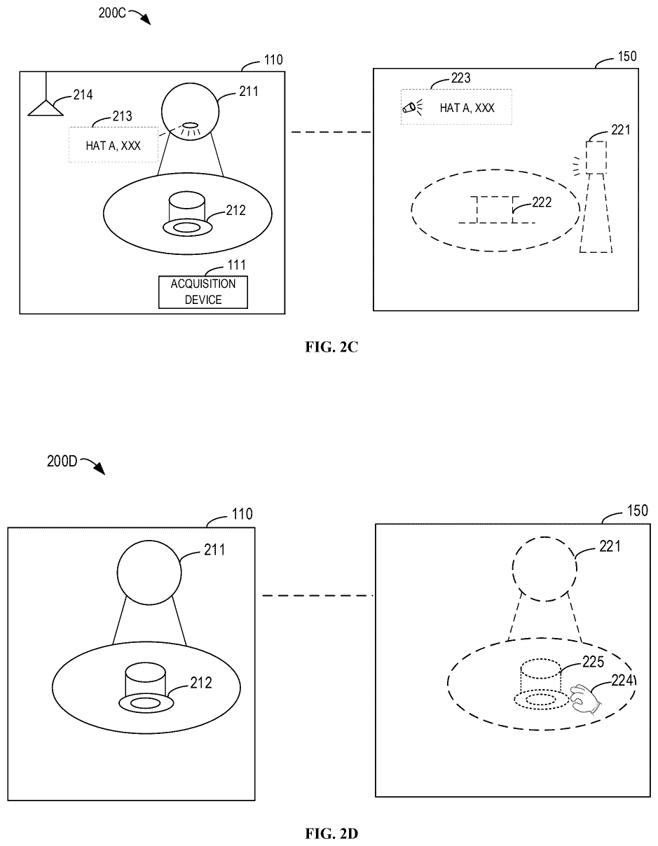

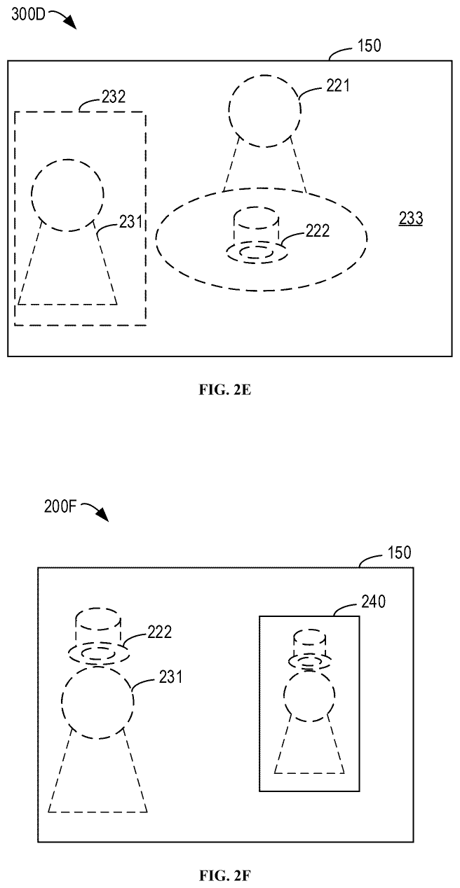

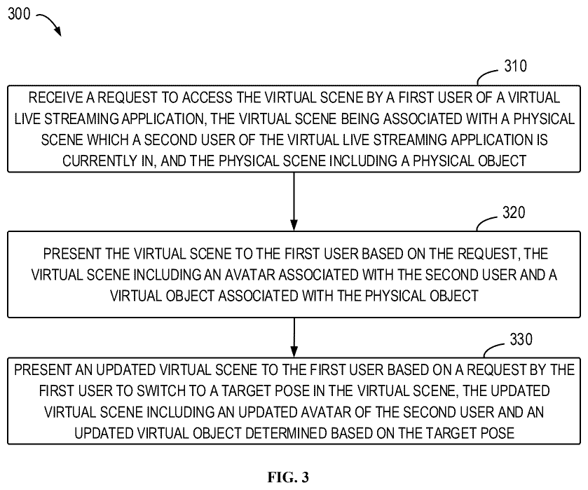

FIG. 2A illustrates a schematic diagram of an example 200A of a virtual scene according to some embodiments of the present disclosure. Such a virtual scene may include, for example, the virtual scene 150. Further, such a virtual scene may include, for example but not limited to, various types of virtual reality scenes, augmented reality scenes, mixed reality scenes, or emulation scenes, etc.

For the convenience of discussion, it will be described at least with reference to the environment 100 in FIG. 1. The server 120 acquires measurement data of a physical scene. In the embodiments of the present disclosure, the server 120 acquires the measurement data of the physical scene from acquisition devices arranged in the physical scene. Such measurement data are, for example, the panoramic image, the three-dimensional point cloud data, etc. discussed above. The physical scene includes a second user (for example, the user 113) and a physical object. For example, in the case that the physical scene is a live streaming room, the second user may be a host of the live streaming room, and the physical object may be a physical product that the host is introducing, has introduced, and will introduce. For another example, in the case that the physical scene is a house, the second user may be a house agent, and the physical object may be furniture in the house.

In some embodiments, an acquisition reference point may be determined based on fixed objects (for example, walls, tables, chairs, chandeliers, etc.) included in the physical scene, so as to facilitate the server 120 to subsequently use the acquisition reference point to quickly determine the spatial layout of the physical scene (for example, the spatial shape of each room in the house, the furniture placement in the house, etc.). In some embodiments, after obtaining the measurement data collected by the acquisition device, the server 120 may also generate a physical size of each physical object based on the measurement data, so as to facilitate the subsequent generation of a virtual object corresponding to the physical object based on the physical size and other sizes, so as to use the virtual object to restore the physical object better and accurately.

As an example, taking the physical scene as the live streaming room as an example, reference is made to FIG. 2A. In FIG. 2A, the server 120 may obtain the measurement data 112 of the physical scene 110 from the acquisition device 111. The physical scene 110 includes a host 211, a hat 212 which the host 211 is recommending, and a chandelier 214.

Further, the server 120 generates a virtual scene associated with the physical scene based on the measurement data. In the embodiments of the present disclosure, the server 120 generates the virtual scene associated with the physical scene based on the obtained measurement data, and the virtual scene includes a virtual object associated with the physical object and an avatar associated with the second user. In some embodiments, the server 120 generates the virtual object of the physical object based on a real texture, a physical shape, and a physical size of the physical object, so that the user can directly observe the information of the physical object associated with the virtual object through the virtual object. In some embodiments, in the case that the second user pre-uploads first description information (for example, an appearance image, a physical shape, a physical size, etc. of the physical object) associated with the physical object, the server 120 may also generate an initial virtual object model based on the description information in advance. Correspondingly, after acquiring the measurement data, the server 120 processes the initial virtual object model with second description information (for example, ambient light information, map information, etc.) associated with the physical object in the measurement data, so as to generate the virtual object. Therefore, the generation efficiency of the virtual object is improved.

In some embodiments, the server 120 may generate a virtual person portrait as the avatar of the second user according to third description information (for example, a face image, a body model, etc.) associated with the second user in the measurement data. In some embodiments, the server 120 may also pre-configure different types of avatars, such as a virtual animal portrait, a virtual host portrait, etc. Correspondingly, the server 120 may select the avatar of the second user from the pre-configured avatars according to the selection of the second user. As such, the avatar of the second user is reasonably selected according to actual needs of the second user, such as a restoration requirement or a fun requirement. For example, in a virtual live streaming room scenario, the server 120 may select a virtual host image associated with the second user (for example, the host) as the avatar of the second user.

As an example, referring to FIG. 2A, the server 120 may generate the virtual scene 150. The virtual scene 150 includes an avatar 221 associated with the host 211, and a virtual hat 222 associated with the hat 212. In some embodiments, the virtual scene 150 further includes a virtual table for placing the virtual hat 222, and a virtual chandelier associated with the chandelier 214 in the physical scene 110 (not shown in the figure).

In some embodiments, in the case of receiving audio data of the second user, the audio data is provided in the virtual scene. Specifically, in the case that the server 120 acquires the audio data of the second user (for example, the explanation audio of the host or the house agent) in the measurement data, the server 120 may further provide the audio data in the generated virtual scene. In this way, the restoration quality of the virtual scene (for example, the virtual scene 150) to the physical scene 110 is further improved. In some embodiments, the server 120 may also play the audio data in association with the avatar, and adjust the playing range and the volume of the audio data adaptively, to further restore the speaking situation of the second user in the physical scene 110.

As an example, referring to FIG. 2A, in the case that the audio data 211 (for example, “hat A, XXX”) that the host 211 is introducing the hat 212 has been collected, the server 120 may also play the audio data 223 in association with the avatar 221.

In some embodiments, the measurement data may be collected in real time. In the case of receiving updated measurement data of the physical scene, a change of the physical scene is determined based on the updated measurement data. Further, the virtual scene is updated based on the change. Specifically, the server 120 receives the updated measurement data of the physical scene. For example, the measurement data used by the server 120 is a panoramic video stream (alternatively and/or additionally, depth data may be further included) continuously collected by the acquisition device 111 in the physical scene 110, and the server 120 may determine a change of the physical scene or the physical object based on a content update in the panoramic video stream. Further, the server 120 may correspondingly adjust the virtual scene based on the update of the physical scene, so as to adapt to the change of the physical scene. As such, the virtual scene can be adjusted in real time with the change of the physical scene, so that the virtual scene is synchronous with the physical scene, and the user interaction experience is guaranteed.

FIG. 2B illustrates a schematic diagram of an example 200B of a virtual scene according to some embodiments of the present disclosure. As an example, reference may be made to FIG. 2B. In FIG. 2B, in the case that the physical object in the physical scene 110 changes, for example, the product placed in front of the host 211 and being introduced changes from the hat 212 to the shampoo 215, the server 120 may correspondingly update the virtual hat 222 in the virtual scene 150 to a virtual shampoo 226, to adjust the virtual scene 150 with the change of the product introduced by the host 211.

In some embodiments, after generating the virtual scene, the server 120 may associate the virtual scene with an application, for example, associating the virtual scene 150 generated in FIG. 2B above with the virtual live streaming application, so that the user (for example, the user 130) can access the virtual scene 150 through the application set in the electronic device 130.

### Example Interaction

The server (for example, the server 120) may receive a request to access the virtual scene (for example, the virtual scene 150) sent by the electronic device (for example, the electronic device 130) used by the user (for example, the user 140), so as to access the virtual scene discussed above, for example. In the embodiments of the present disclosure, the server 120 may receive a request to access the virtual scene sent by the user using the electronic device, for example, the virtual scene presenting function of the virtual live streaming application in the electronic device used by the user. As an example, reference may be made to FIG. 1, the server 120 may receive a request to access the virtual scene (for example, the virtual scene 150) sent by the user 140 using the virtual live streaming application in the electronic device 130. In some embodiments, such a virtual scene is associated with a physical scene (for example, the live streaming room 110) which a second user (for example, a host) of the virtual live streaming application is currently in.

Further, the server 120 presents the virtual scene to the first user based on the above request. In the embodiments of the present disclosure, the virtual scene includes an avatar associated with the second user and a virtual object associated with the physical object. As an example, such a virtual scene may refer to the virtual scene 150 in FIG. 2A, which includes an avatar 221 associated with the second user and a virtual object 225 associated with the physical object.

In some embodiments, the updated virtual scene is presented by a wearable electronic device worn by the first user. Specifically, the first user (for example, the user 140) may use the wearable electronic device (for example, the electronic device 130, such as a head-mounted display, smart glasses, etc.) to send an access request to the server 120. The server 120 returns data for presenting the virtual scene to the wearable electronic device according to the access request sent by the wearable electronic device. The wearable electronic device presents the virtual scene to the first user based on the data returned by the server 120. Therefore, the first user can access and interact with the virtual scene associated with the physical scene including the virtual first user and the physical object, by using the wearable electronic device.

As an example, referring to FIG. 2A, the electronic device 130 may present the virtual scene 150 illustrated in FIG. 2A to the user 140. The user 140 may get knowledge of the situation in the physical scene 110 through the virtual scene 150. For example, in the case that the physical scene is a live streaming room, the user 140 may watch the live streaming in the “immersive” live streaming room through the virtual scene 150, and use the virtual object to watch and perceive the products introduced by the host in real time and intuitively, so as to have a more intuitive understanding of the content introduced by the host.

Further, the electronic device 130 presents an updated virtual scene to the first user based on a request by the first user to switch to a target pose in the virtual scene, the updated virtual scene including an updated avatar of the second user and an updated virtual object determined based on the target pose. In the embodiments of the present disclosure, the electronic device 130 may determine the content of the virtual scene presented to the first user according to the pose, and adjust the pose according to the switching request of the first user, and then update the content in the virtual scene (for example, the electronic device 130 correspondingly updates the virtual scene according to the request of the first user to switch from the current pose to the target pose). In some embodiments, such a pose includes a position and an orientation. In some embodiments, the position may be determined based on a viewpoint (for example, an observation position of the first user in the virtual scene configured by the electronic device 130). In some embodiments, the orientation may be determined based on the orientation of the field of vision of the first user, for example, an angle with a reference coordinate axis (for example, x, y, z axes) in a spatial coordinate system, and Euler angles (for example, a pitch angle, a yaw angle, and a roll angle) in a carrier coordinate system. For example, in the case that the position is a position at the edge of a table in the virtual live streaming room, the electronic device 130 may select, based on the position, a content corresponding to a certain range (for example, the entire tabletop) in the virtual scene to present. Further, the electronic device 130 may adjust the position according to the user. For example, the electronic device 130 determines a position that the user expects to go to according to the movement of the first user, the input moving coordinates, etc., and then moves accordingly. Further, the electronic device 130 may update the virtual scene provided to the first user according to the position switched by the first user, so as to present the updated virtual scene to the first user. For example, the electronic device 130 presents the content of the space in which each room is located in the virtual scene to the first user according to the pose in which the first user is currently placed (for example, each room in the house). As such, the content presented in the virtual scene is adjusted according to the position change of the first user, so that the first user is provided with the same interaction experience as the physical scene.

As an example, reference may be made to FIG. 2C, which illustrates a schematic diagram of an example 200C of a virtual scene according to some embodiments of the present disclosure. In FIG. 2C, in the case that the position switched by the user 140 is on the left of the avatar 221 of the second user in the virtual scene, the electronic device 130 may correspondingly adjust the virtual scene 150, so that the content presented is consistent with the situation that the user 140 observes the second user 211 on the left.

In some embodiments, presenting the updated virtual scene to the first user includes: determining a field of vision of the first user in the virtual scene based on a pose of the first user. Further, a portion of the field of vision in the virtual scene is presented to the first user in order to present the virtual scene to the first user, the field of vision of the first user in the virtual scene is determined based on the pose of the first user. Specifically, the electronic device 130 may determine the field of vision of the first user in the virtual scene according to the pose of the first user, for example, the field of vision of the first user in the virtual scene is determined based on the pose of the first user in the virtual scene. In some embodiments, the electronic device 130 may also pre-set a field of vision distance and/or a parameter, so as to determine a target field of vision area based on the field of vision distance and/or the parameter and the position of the first user, after the pose of the first user is determined. Further, the electronic device 130 presents the portion in the field of vision in the virtual scene to the first user. Therefore, the content presented and rendered in the virtual scene may be determined based on the visual range of the first user, and the operation pressure of the electronic device 130 can be reduced.

As an example, referring to FIG. 2A, after determining the field of vision of the user 140, the electronic device 130 only presents the content in the field of vision in the virtual scene 150 to the user 140. For example, in the case that the virtual object associated with the chandelier 214 is outside the field of vision, the server 120 does not present the virtual object associated with the chandelier 214 in the virtual scene 150.

In some embodiments, the electronic device 130 acquires a prestored virtual object of the physical object, in the case of receiving an interaction request of the first user with the virtual object. Further, the virtual object in the virtual scene is replaced with the prestored virtual object. Specifically, the user 140 may interact in the virtual scene (for example, the virtual scene 150) through the electronic device 130. In some embodiments, the virtual scene may further provide an icon object for the user 140, so as to facilitate interaction with the virtual object in the virtual scene by using an icon image. For example, a virtual hand icon is provided, so that the user 140 can select the virtual object by controlling the hand icon, and perform interactive operations such as moving the virtual object.

Further, in the case that the user 140 interacts with the virtual object, for example, the user 140 selects the virtual object (for example, a product being introduced in the live streaming room, furniture displayed in the house), the electronic device 130 acquires the prestored virtual object of the physical object. The prestored virtual object is pre-configured, and is a virtual object that is more complete and clearer than the virtual object currently presented in the virtual environment. Therefore, a virtual object with relatively low resolution and quality may be generated in the initial stage of the live streaming. In the case that there is the prestored virtual object, and the user selects the virtual object that the user desires to get knowledge of, the prestored virtual object with richer details and higher quality is presented to the user, so that richer visual information is provided to the user.

As an example, reference may be made to FIG. 2D, which illustrates a schematic diagram of an example 200D of a virtual scene according to some embodiments of the present disclosure. In the virtual environment 150 illustrated in FIG. 2D, a hand icon 224 for the user 140 to operate is also presented in the virtual environment. Further, after detecting that the user 140 selects the virtual hat 222 through the hand icon 224, the electronic device 130 updates the virtual hat 222 to a stored virtual hat 225.

In some embodiments, the prestored virtual object has higher precision than the virtual object. Specifically, during the generation of the high-precision prestored virtual object, the server 120 may use a high-precision acquisition device to acquire the measurement data, and model the physical object, so as to generate the high-precision prestored virtual object by using the higher-precision measurement data. For example, a high-precision acquisition physical space may be pre-configured, for example, a higher-precision acquisition device is configured in such a high-precision acquisition physical space. Correspondingly, a relevant person such as a host or a product provider may place a physical product in the high-precision acquisition physical space to acquire the measurement data, thereby obtaining the above-mentioned higher-precision measurement data, and generating the prestored virtual object accordingly. The precision of such a prestored virtual object is higher than that of the virtual object. Therefore, in this way, high-precision information acquisition can be performed on the physical object in advance, so as to provide a higher-quality (stored) virtual object for the viewer (the first user), and restore the physical object better.

In some embodiments, the electronic device 130 may also perform, for example, a zoom-in function on the virtual object according to the virtual object selected by the first user, so as to facilitate the first user to better observe the details of the virtual object.

In some embodiments, the server 120 may also configure effects in the virtual scene accordingly, according to other operations of the first user in the virtual scene, to enhance the interaction. Such other operations are, for example, a gift sending operation, for example, an operation of selecting the avatar of the second user to send the effects. For example, the server 120 may change the virtual avatar of the second user by sending a gift, for example, adding “effect glasses” and “effect masks” to the original virtual avatar of the second user.

In some embodiments, the electronic device 130 may further provide an avatar associated with the first user in the virtual scene. Specifically, in the case that the electronic device 130 presents the virtual scene to the first user, the electronic device 130 may further provide the avatar associated with the first user in the virtual scene. Therefore, the user may use the avatar to achieve more diverse interactions in the virtual scene. For example, the user may use the avatar to walk around in the virtual scene to better observe the spatial layout of the virtual scene (for example, the live streaming room), and interact with avatars of other users, so as to enhance the interaction experience of the first user. In some embodiments, such an avatar is similar to the first avatar. Similarly, the electronic device 130 may generate a virtual person portrait as the avatar of the first user according to fourth description information (for example, a face image, a body model, etc.) of the first user, or the avatar of the first user may be selected from the pre-configured avatars according to the first user, for example, a virtual animal portrait, a virtual viewer portrait, etc.

In some embodiments, in order to provide the avatar, the electronic device 130 may determine the pose of the avatar based on the pose of the first user. Further, the avatar is presented in the virtual scene according to the pose. Specifically, in the case that the electronic device 130 provides the avatar for the first user, the pose of the avatar (for example, the pose including the position and orientation discussed above. In this case, for example, a viewpoint position is adjusted to the position of the avatar in the virtual scene) may be determined based on the pose of the first user, and the avatar is presented in the virtual scene according to the pose.

Therefore, the position of the avatar may be adjusted by capturing the pose of the first user, so as to realize synchronization and association between the first user and the avatar, and the first user may use the avatar to achieve better interaction in the virtual scene. For example, the avatar is controlled to walk around in the virtual scene (for example, the live streaming room, each room in the house), and the state of the avatar (for example, standing, sitting, squatting, body orientation, etc.) is controlled, for example, a virtual object is observed from multiple angles in the virtual live streaming room. In some embodiments, the electronic device 130 may determine the field of vision discussed above based on the pose of the avatar, so as to better restore the observation state of the first user.

As an example, reference may be made to FIG. 2E, which illustrates a schematic diagram of an example 200E of a virtual scene according to some embodiments of the present disclosure. In FIG. 2E, the electronic device 130 may adjust the second virtual avatar from a position 223 to a position 233 based on the pose change of the user 140, and adjust an observation pose of the virtual avatar 231 (for example, adjust a body orientation of the virtual avatar 231).

In some embodiments, if an interaction request of the first user with the virtual object is received, a pose of the virtual object in the virtual scene is changed based on the interaction request. Specifically, in the case that the electronic device 130 receives the interaction request of the first user with the virtual object, such an interaction request indicates an interaction operation that the first user expects to perform with the virtual object. For example, picking up the virtual object, trying on the virtual object, changing the orientation of the virtual object, deleting the virtual object, etc. Further, the electronic device 130 changes the pose of the virtual object in the virtual scene based on the interaction request (for example, the pose including the position and orientation discussed above. In this case, for example, a viewpoint position is adjusted to the position of the second virtual avatar in the virtual scene).

For example, in the case that the interaction request is to try on a hat, 130 may change the position of the virtual object (for example, the virtual hat 222) in the virtual scene (for example, the virtual scene 150) to a head of the virtual avatar (for example, the virtual avatar 231) of the first user. In some embodiments, the electronic device 130 may also set the pose of the virtual object (the virtual hat 222) to change in association with the virtual avatar (for example, the virtual avatar 231) of the first user. For example, in the case that the virtual avatar jumps, the virtual hat also moves up and down. Therefore, the same interaction experience in the physical scene can be provided for the first user in the virtual scene, so that the user can try on and adjust the virtual object, etc., which is convenient for the user to get better knowledge of the virtual object.

In some embodiments, the virtual scene further includes a virtual mirror. In this case, a mirror image of a combination of the virtual avatar of the first user and the virtual object may be presented in the virtual mirror. Specifically, the server 120 may further configure a virtual mirror in the virtual scene, and the virtual mirror may be used to present a mirror image of a combination of the second virtual avatar and the virtual object. In the case that the target pose switched by the first user is associated with the virtual mirror (for example, the first user operates the virtual avatar to enter an area associated with the virtual mirror, selects the virtual mirror, etc.), the electronic device 130 presents, in the virtual mirror, the mirror image of the combination of the virtual avatar associated with the first user and the virtual object. Therefore, it is convenient for the user to use the virtual mirror to observe the mirror image of the combination of the second virtual avatar and the virtual object, so as to present a try-on effect. Correspondingly, the user is assisted in making a decision on whether to purchase the physical object corresponding to the virtual object, for example, whether to purchase a hat corresponding to the virtual hat.

As an example, reference may be made to FIG. 2F, which illustrates a schematic diagram of an example 200F of a virtual scene according to some embodiments of the present disclosure. In FIG. 2F, the virtual scene 150 further includes a virtual mirror 240. The user 140 may send an interaction request of selecting the virtual hat 222 and trying on the virtual hat 222. The electronic device 130 configures a combined image of the virtual avatar 231 and the virtual hat 222. Further, the user 140 may use the virtual mirror 240 by controlling the virtual avatar 231, for example, controlling the virtual avatar to move into an area within a certain range in front of the virtual mirror 240, or selecting the virtual mirror 240. Correspondingly, the electronic device 130 controls to present, in the virtual mirror 240, the combined image of the virtual avatar 231 and the virtual hat 222, so as to facilitate the user 140 to observe the try-on effect of the virtual hat 222, thereby assisting the user 140 in deciding whether to purchase the hat 212.

In this way, the embodiments of the present disclosure generate a virtual scene associated with the physical scene which the second user is currently in and the physical object included in the physical scene. Therefore, the first user can perceive and experience the physical scene in which the second user is placed and the physical object existing in the physical scene, by accessing the virtual scene, which provides the first user with an interaction feeling close to interacting with the second user and the physical object in the physical scene. On this basis, the presentation content for the first user may be adjusted according to the pose of the first user in the virtual scene, so as to further enhance the interaction experience of the first user in the virtual scene.

### Example Process

FIG. 3 illustrates a flow chart of a process 300 of presenting a virtual scene according to some embodiments of the present disclosure. As an example, the process 300 may be implemented independently by the electronic device 110 in FIG. 1, or may be implemented by a combination of the electronic device 110 and other computing devices. For the convenience of discussion, the process 300 will be described in conjunction with FIG. 1.

As shown in FIG. 3, at block 310, the electronic device 130 receives a request to access the virtual scene by a first user of a virtual live streaming application, the virtual scene being associated with a physical scene which a second user of the virtual live streaming application is currently in, and the physical scene including a physical object.

At block 320, the electronic device 130 presents the virtual scene to the first user based on the request, the virtual scene including an avatar associated with the second user and a virtual object associated with the physical object.

At block 330, the electronic device 130 presents an updated virtual scene to the first user based on a request by the first user to switch to a target pose in the virtual scene, the updated virtual scene including an updated avatar of the second user and an updated virtual object determined based on the target pose.

In some embodiments, the electronic device 130 presenting the updated virtual scene to the first user includes: determining a field of vision of the first user in the virtual scene based on the pose of the first user. Further, a portion of the field of vision in the virtual scene is presented to the first user.

In some embodiments, in response to receiving an interaction request of the first user with the virtual object, the electronic device 130 may further obtain a prestored virtual object of the physical object. Further, the virtual object in the virtual scene is replaced with the prestored virtual object.

In some embodiments, the prestored virtual object has higher precision than the virtual object.

In some embodiments, the electronic device 130 may further provide an avatar associated with the first user in the virtual scene.

In some embodiments, the electronic device 130 providing the avatar associated with the first user includes: determining a pose of the avatar associated with the first user based on the pose of the first user. Further, the avatar associated with the first user is presented in the virtual scene according to the pose.

In some embodiments, in response to receiving an interaction request of the first user with the virtual object, the electronic device 130 may further change a pose of the virtual object in the virtual scene based on the interaction request.

In some embodiments, the virtual scene further includes a virtual mirror, and the electronic device 130 presenting the updated virtual scene to the first user includes: in response to the target pose being associated with the virtual mirror, presenting, in the virtual mirror, a mirror image of a combination of the avatar associated with the first user and the virtual object.

In some embodiments, the electronic device 130 may further obtain measurement data of the physical scene. Further, the virtual scene associated with the physical scene is generated based on the measurement data.

In some embodiments, the electronic device 130 may further provide audio data in the virtual scene in response to receiving audio data of the second user.

In some embodiments, in response to receiving updated measurement data of the physical scene, the electronic device 130 may further determine a change of the physical scene based on the updated measurement data. Further, the virtual scene is adjusted based on the change.

In some embodiments, the electronic device 130 presenting the updated virtual scene to the first user includes: presenting the updated virtual scene to a wearable electronic device worn by the first user.

In some embodiments, the physical scene is a live streaming room, the first user is a viewer, the second user is a host, the physical object is an item in the live streaming room, and the virtual scene is a virtual scene based on a three-dimensional model.

### Example Apparatus and Device

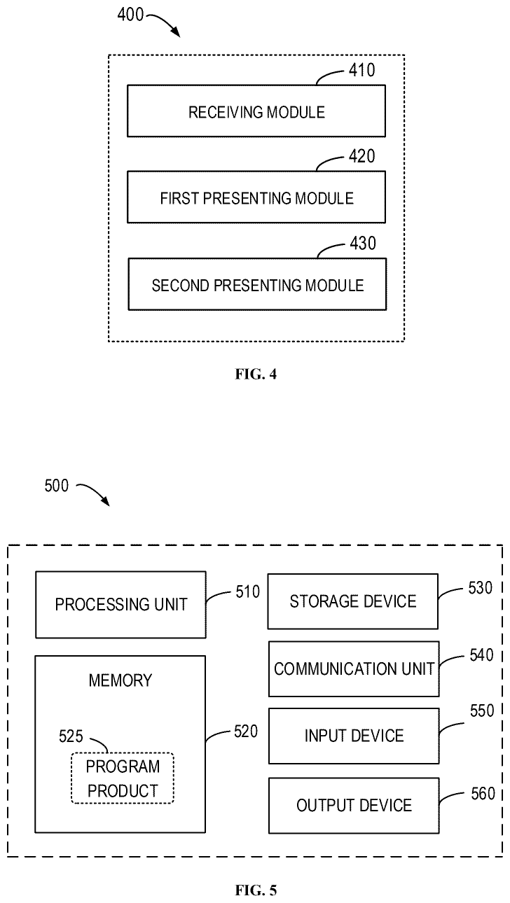

Embodiments of the present disclosure further provide corresponding apparatuses for implementing the above-mentioned methods or processes. FIG. 4 illustrates a schematic block diagram of an apparatus 400 for presenting a virtual scene according to some embodiments of the present disclosure.

As shown in FIG. 4, the apparatus 400 includes a receiving module 410 configured to receive a request to access a virtual scene by a first user of a virtual live streaming application, the virtual scene being associated with a physical scene which a second user of the virtual live streaming application is currently in, and the physical scene including a physical object. In addition, the apparatus 400 further includes a first presenting module 420 configured to present the virtual scene to the first user based on the request, the virtual scene including an avatar associated with the second user and a virtual object associated with the physical object. In addition, the apparatus 400 further includes a second presenting module 430 configured to present an updated virtual scene to the first user based on a request by the first user to switch to a target pose in the virtual scene, the updated virtual scene including an updated avatar of the second user and an updated virtual object determined based on the target pose.

In some embodiments, the second presenting module 430 includes: a first determination sub-module configured to determine a field of vision of the first user in the virtual scene based on the target pose of the first user. In addition, the second presenting module 430 further includes: a first presenting sub-module configured to present a portion of the field of vision in the virtual scene to the first user.

In some embodiments, a replacement module is configured to, in response to receiving an interaction request of the first user with the virtual object, obtain a prestored virtual object of the physical object. Further, the virtual object in the virtual scene is replaced with the prestored virtual object.

In some embodiments, the prestored virtual object has higher precision than the virtual object.

In some embodiments, the apparatus 400 further includes a first provision module configured to provide an avatar associated with the first user in the virtual scene.

In some embodiments, the first provision module includes a second determination sub-module configured to determine a pose of the avatar associated with the first user based on the target pose of the first user. The first provision module further includes a second presenting sub-module configured to present the avatar associated with the first user in the virtual scene according to the pose.

In some embodiments, the apparatus 400 further includes: a change module configured to, in response to receiving an interaction request of the first user with the virtual object, change a pose of the virtual object in the virtual scene based on the interaction request.

In some embodiments, the virtual scene further includes a virtual mirror, and the second presenting module 430 in the apparatus 400 is further configured to, in response to the target pose being associated with the virtual mirror, present, in the virtual mirror, a mirror image of a combination of the avatar associated with the first user and the virtual object.

In some embodiments, the apparatus 400 further includes an obtaining module configured to obtain measurement data of the physical scene. In addition, the apparatus 400 further includes a generation module configured to generate the virtual scene associated with the physical scene based on the measurement data.

In some embodiments, the apparatus 400 further includes a second provision module configured to, in response to receiving audio data of the second user, provide the audio data in the virtual scene.

In some embodiments, the apparatus 400 further includes an adjustment module configured to, in response to receiving updated measurement data of the physical scene, determine a change of the physical scene based on the updated measurement data. Further, the virtual scene is adjusted based on the change.

In some embodiments, the second presenting module 430 is further configured to present the updated virtual scene to a wearable electronic device worn by the first user.

In some embodiments, the physical scene in the apparatus 400 is a live streaming room, the first user is a host, the second user is a viewer, the physical object is an item in the live streaming room, and the virtual scene is a virtual scene based on a three-dimensional model.

The modules included in the apparatus 400 may be implemented in various ways, including software, hardware, firmware, or any combination thereof. In some embodiments, one or more modules (or units) may be implemented using software and/or firmware,, for example, machine-executable instructions stored on a storage medium. In addition to or as an alternative to the machine-executable instructions, some or all of the modules in the apparatus 400 may be implemented at least partially by one or more hardware logic components. As an example rather than a limitation, exemplary types of hardware logic components that can be used include a field programmable gate array (FPGA), an application specific integrated circuit (ASIC), an application specific standard product (ASSP), a system on chip (SOC), a complex programmable logic device (CPLD), and the like. Furthermore, in some embodiments, multiple functions implemented by a module may be implemented by sub-modules or other independent modules included therein. For example, the virtual scene being presented to the second user is implemented by the presenting module 430, and in response to receiving the access request of the second user to access the virtual scene, the virtual scene being presented to the second user (for example, the presenting module in the electronic device used by the user) may be further implemented by the presenting module 430 or implemented by other presenting modules independent of the presenting module 430, which is not limited in the present disclosure.

FIG. 5 illustrates a block diagram of an electronic device/server 500 in which one or more embodiments of the present disclosure can be implemented. It should be understood that the electronic device/server 500 shown in FIG. 5 is only exemplary, and should not constitute any limitation to the functions and scope of the embodiments described herein.

As shown in FIG. 5, the electronic device/server 500 is in the form of a general electronic device. The components of the electronic device/server 500 may include, but are not limited to, one or more processors or processing units 510, a memory 520, a storage device 530, one or more communication units 540, one or more input devices 550, and one or more output devices 560. The processing unit 510 may be an actual or virtual processor and may be capable of executing various processes according to programs stored in the memory 520. In a multi-processor system, multiple processing units execute computer-executable instructions in parallel to improve the parallel processing capability of the electronic device/server 500.

The electronic device/server 500 generally includes multiple computer storage media. Such media may be any available media accessible by the electronic device/server 500, including but not limited to volatile and non-volatile media, removable and non-removable media. The memory 520 may be a volatile memory (e.g., register, cache, random access memory (RAM)), non-volatile memory (e.g., read-only memory (ROM), electrically erasable programmable read-only memory (EEPROM), flash), or some combination thereof. The storage device 530 may be a removable or non-removable medium, and may include a machine-readable medium, such as a flash drive, a disk, or any other medium that can be used to store information and/or data (e.g., training data for training) and can be accessed within the electronic device/server 500.

The electronic device/server 500 may further include additional removable/non-removable, volatile/non-volatile storage media. Although not shown in FIG. 5, a disk drive for reading from or writing to a removable, non-volatile disk (e.g., a “floppy disk”) and an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 enables communication with other electronic devices through a communication medium. Additionally, the functions of the components of the electronic device/server 500 may be implemented in a single computing cluster or multiple computing machines that can communicate through communication connections. Therefore, the electronic device/server 500 may operate in a networked environment using a logical connection with one or more other servers, a network personal computer (PC), or another network node.

The input device 550 may be one or more input devices, such as a mouse, a keyboard, a trackball, etc. The output device 570 may be one or more output devices, such as a display, a speaker, a printer, etc. The electronic device/server 500 may also communicate with one or more external devices (not shown) such as a storage device, a display device, etc., through the communication unit 540 as required, communicate with one or more devices that enable the user to interact with the electronic device/server 500, or communicate with any device (such as a network card, a modem, etc.) that enables the electronic device/server 500 to communicate with one or more other electronic devices. Such communication may be performed via an input/output (I/O) interface (not shown).

According to an example implementation of the present disclosure, a computer-readable storage medium is provided, on which one or more computer instructions are stored, and the one or more computer instructions are executed by a processor to implement the above-described method.

Various aspects of the present disclosure are described herein with reference to flowcharts and/or block diagrams of methods, apparatus (systems) and computer program products implemented according to the present disclosure. It should be understood that each block of the flowchart and/or block diagram and a combination of blocks in the flowchart and/or block diagram may be implemented by computer-readable program instructions.

These computer-readable program instructions may be provided to a processing unit of a general-purpose computer, a special-purpose computer, or other programmable data processing apparatus, so as to produce a machine, such that the instructions, when executed by the processing unit of the computer or other programmable data processing apparatus, produce an apparatus for implementing the functions/actions specified in one or more blocks in the flow chart and/or block diagram. These computer-readable program instructions may also be stored in a computer-readable storage medium. These instructions cause the computer, the programmable data processing apparatus, and/or other devices to work in a specific way. Thus, the computer-readable medium having instructions stored thereon includes an article of manufacture, which includes instructions for implementing various aspects of the functions/actions specified in one or more blocks in the flow chart and/or block diagram.

These computer-readable program instructions may also be loaded onto a computer, other programmable data processing apparatus, or other device, such that a series of operational steps are performed on the computer, other programmable data processing apparatus, or other device to produce a computer-implemented process, such that the instructions executed on the computer, other programmable data processing apparatus, or other device implement the functions/actions specified in one or more blocks in the flow chart and/or block diagram.

The flowcharts and block diagrams in the drawings show possible architectures, functions and operations of the system, method and computer program product implemented according to multiple implementations of the present disclosure. In this regard, each block in the flow chart or block diagram may represent a module, a program segment, or a part of an instruction, and the module, the program segment, or the part of the instruction contains one or more executable instructions for implementing a specified logical function. In some alternative implementations, the functions marked in the blocks may also occur in a different order from the order marked in the drawings. For example, two consecutive blocks may actually be executed substantially in parallel, or sometimes may be executed in a reverse order, depending on the functions involved. It should also be noted that each block in the block diagram and/or flowchart, and a combination of blocks in the block diagram and/or flowchart, may be implemented by a dedicated hardware-based system that performs specified functions or actions, or may be implemented by a combination of dedicated hardware and computer instructions.

Various implementations of the present disclosure have been described above, and the above description is exemplary and non-exhaustive, and is not limited to the disclosed implementations. Many modifications and changes are obvious to those skilled in the art without departing from the scope and spirit of the described implementations. The choice of terms used herein is intended to best explain the principles, practical applications or improvements in the technology in the market, or to enable other ordinary skilled in the art to understand the implementations disclosed herein.

1-17. (canceled)

18. A method for presenting a virtual scene, comprising:
receiving a request to access the virtual scene by a first user of a virtual live streaming application, the virtual scene being associated with a physical scene which a second user of the virtual live streaming application is currently in, and the physical scene comprising a physical object;
presenting the virtual scene to the first user based on the request, the virtual scene comprising an avatar associated with the second user and a virtual object associated with the physical object; and
presenting an updated virtual scene to the first user based on a request by the first user to switch to a target pose in the virtual scene, the updated virtual scene comprising an updated avatar of the second user and an updated virtual object determined based on the target pose.

19. The method according to claim 18, wherein presenting the updated virtual scene to the first user comprises:
determining a field of vision of the first user in the virtual scene based on the target pose of the first user; and
presenting a portion of the field of vision in the virtual scene to the first user.

20. The method according to claim 18, further comprising: in response to receiving an interaction request of the first user with the virtual object,
obtaining a prestored virtual object of the physical object; and
replacing the virtual object in the virtual scene with the prestored virtual object.

21. The method according to claim 20, wherein the prestored virtual object has higher precision than the virtual object.

22. The method according to claim 18, further comprising: providing an avatar associated with the first user in the virtual scene.

23. The method according to claim 22, wherein providing the avatar associated with the first user comprises:
determining a pose of the avatar associated with the first user based on the target pose of the first user; and
presenting the avatar associated with the first user in the virtual scene according to the pose.

24. The method according to claim 22, further comprising:
in response to receiving an interaction request of the first user with the virtual object, changing a pose of the virtual object in the virtual scene based on the interaction request.

25. The method according to claim 24, wherein the virtual scene further comprises a virtual mirror, and presenting the updated virtual scene to the first user comprises:
in response to the target pose being associated with the virtual mirror, presenting, in the virtual mirror, a mirror image of a combination of the avatar associated with the first user and the virtual object.

26. The method according to claim 18, further comprising:
obtaining measurement data of the physical scene; and
generating the virtual scene associated with the physical scene based on the measurement data.

27. The method according to claim 26, further comprising:
in response to receiving audio data of the second user, providing the audio data in the virtual scene.

28. The method according to claim 26, further comprising:
in response to receiving updated measurement data of the physical scene, determining a change of the physical scene based on the updated measurement data; and
adjusting the virtual scene based on the change.

29. The method according to claim 18, wherein presenting the updated virtual scene to the first user comprises:
presenting the updated virtual scene to a wearable electronic device worn by the first user.

30. The method according to claim 18, wherein the physical scene is a live streaming room, the first user is a viewer, the second user is a host, the physical object is an item in the live streaming room, and the virtual scene is a virtual scene based on a three-dimensional model.

31. An electronic device, comprising:
a memory and a processor,
wherein the memory stores one or more computer instructions, and the one or more computer instructions are executed by the processor to implement acts comprising:
receiving a request to access a virtual scene by a first user of a virtual live streaming application, the virtual scene being associated with a physical scene which a second user of the virtual live streaming application is currently in, and the physical scene comprising a physical object;
presenting the virtual scene to the first user based on the request, the virtual scene comprising an avatar associated with the second user and a virtual object associated with the physical object; and
presenting an updated virtual scene to the first user based on a request by the first user to switch to a target pose in the virtual scene, the updated virtual scene comprising an updated avatar of the second user and an updated virtual object determined based on the target pose.

32. The device according to claim 31, wherein presenting the updated virtual scene to the first user comprises:
determining a field of vision of the first user in the virtual scene based on the target pose of the first user; and
presenting a portion of the field of vision in the virtual scene to the first user.

33. The device according to claim 31, wherein the acts further comprise: in response to receiving an interaction request of the first user with the virtual object,
obtaining a prestored virtual object of the physical object; and
replacing the virtual object in the virtual scene with the prestored virtual object.

34. The device according to claim 31, wherein the acts further comprise: providing an avatar associated with the first user in the virtual scene.

35. The device according to claim 34, wherein providing the avatar associated with the first user comprises:
determining a pose of the avatar associated with the first user based on the target pose of the first user; and
presenting the avatar associated with the first user in the virtual scene according to the pose.

36. The device according to claim 31, wherein the acts further comprise:
obtaining measurement data of the physical scene; and
generating the virtual scene associated with the physical scene based on the measurement data.

37. A non-transitory computer-readable storage medium having stored thereon one or more computer instructions, wherein the one or more computer instructions are executed by a processor to implement acts comprise:
receiving a request to access a virtual scene by a first user of a virtual live streaming application, the virtual scene being associated with a physical scene which a second user of the virtual live streaming application is currently in, and the physical scene comprising a physical object;
presenting the virtual scene to the first user based on the request, the virtual scene comprising an avatar associated with the second user and a virtual object associated with the physical object; and
presenting an updated virtual scene to the first user based on a request by the first user to switch to a target pose in the virtual scene, the updated virtual scene comprising an updated avatar of the second user and an updated virtual object determined based on the target pose.
